(19) United States
(12) Patent Application Publication
(10) Pub. No.: US 2026/0154282 A1
(43) Pub. Date: Jun. 4, 2026

(54) System, Method, and Device for Data Management in A Mainframe Environment

(71) Applicant: The Toronto-Dominion Bank, Toronto (CA)

(72) Inventors: Ivan CHAN, Toronto (CA); Julian SENGBOUPHA, Toronto (CA); Mariia KRAVCHENKO, Toronto (CA); Aayush KATHURIA, Brampton (CA)

(73) Assignee: The Toronto-Dominion Bank, Toronto (CA)

(21) Appl. No.: 18/964,131

(22) Filed: Nov. 29, 2024

(51) Int. Cl. G06F 16/248; G06F 16/2458

(52) U.S. Cl. CPC G06F 16/248; G06F 16/2465

(57) ABSTRACT

System, method and device for managing mainframe data. The method includes providing a data management platform coupled to a mainframe; providing access, via the data management platform, to a job engine, the job engine configured to execute at least one data job; generating a data model for a plurality of portions of the mainframe, each portion of the mainframe comprising a portion of the mainframe data provided in a corresponding format associated with operations executed by that portion of the plurality of mainframe portions; generating a data model job executable by the job engine, the data model job configured to use the data model to access specific ones of the plurality of mainframe portions based on queries received by the data management platform via the user interface; executing the data model job to access mainframe data from at least a plurality of the mainframe portions and process the accessed mainframe data to provide a readable format; and presenting the processed mainframe data.

### TECHNICAL FIELD

The following relates generally to methods for data management, and more specifically to data management in a mainframe environment.

### BACKGROUND

Testing systems, applications and processes requires not only access to test data to perform the tests, but also knowledge of how the systems, applications and processes are meant to work, the nature of the test environment, the nature of the production environment, etc. Moreover, many tests require access to data from multiple systems and this can add to the complexity for test engineers. This may be particularly challenging when dealing with mainframe environments. Similar challenges face users that need access to data in a mainframe for other data management purposes.

Despite being a relatively old technology, mainframes continue to be prominent in certain businesses for certain applications. Mainframes can be used for applications which are sensitive, and as a result of their relative longevity and lack of testing, they can run dated processes that are hard to understand for unfamiliar users.

As a result of their relative scarcity, the sensitivity of the information processed, and the specificity of the application, searching data, accessing data, testing data and executing jobs within mainframe environments is challenging. For example, the expertise required to test in a mainframe environment can be scarce, both in terms of interacting with a mainframe specifically, and with respect to interacting with potentially large amounts of legacy jobs and processes that have been maintained on the mainframe given their longevity. Mainframes, as a result of the sensitive data they process, can have strict access protocols reducing access to testing generally.

Unlike more modern computing architecture, and a factor in introducing friction to using mainframes more generally, mainframes can have limited and archaic user interfaces. These user interfaces can preclude a more widespread ability to interact with mainframe environments.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of a data management platform.

FIG. 3 is a block diagram of an example configuration for an enterprise system having a mainframe.

FIG. 4 illustrates a data training workflow process.

FIG. 5 illustrates a front-end asset list workflow process using custom applications.

FIG. 6 illustrates a data mining and reservation workflow process having access to an internal data model.

FIG. 7 illustrates a data model job having access to multiple different entities in an enterprise system that utilize a mainframe.

FIG. 8 illustrates a reporting list workflow process using a job engine to access reporting jobs.

FIG. 9 is a block diagram of an example configuration of a client device used to interface with, for example, the self-serve data platform.

FIG. 10 is a flow chart illustrating example operations that may be performed in managing mainframe data.

FIG. 11 is a flow chart illustrating example operations that may be performed in reserving data in accessed portions of a mainframe to control data access.

FIG. 12 is a flow chart illustrating example operations that may be performed in executing custom programs to test at least a host application in a test region and/or an application programming interface (API) in the test region.

FIG. 13 is a flow chart illustrating example operations that may be performed in providing access to a collaboration software, a training repository, and/or external resource locators via a data training module.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following generally relates to data management, particularly in a mainframe environment in which the mainframe of an enterprise has multiple portions, each associated with an entity, unit, application, server, or component of the enterprise's system. A system is described herein that provides a platform to provide users with the ability to acquire test data and knowledge quickly through access to specific domain knowledge.

Testing systems, applications and processes requires not only access to test data to perform the tests, but also knowledge of how the systems, applications and processes are meant to work, the nature of the test environment, the nature of the production environment, etc. Moreover, many tests require access to data from multiple systems and this can add to the complexity for test engineers.

A challenge is how to provide users with the ability to acquire test data and knowledge quickly, efficiently, and accurately. The system described herein enables an enterprise to deploy a self-served data management platform, which creates a central console and portal into multiple systems used for processing data, such as test data generated in a mainframe environment.

The data management platform provides users with the ability to acquire test data and knowledge quickly by providing access to specific domain knowledge as well as access to data jobs that can be scheduled for execution. The platform inserts data into databases directly and through web services and APIs. This enables the platform to keep referential integrity to ensure usable data across multiple systems in the same environment.

The platform is also configured to access data mining models that can be used for data searching that allows for searching on any field and can reserve the entire customer record. The platform is also configured to access test data related reporting. The platform can be configured to serve test data related challenges.

The platform can access specific data knowledge by providing a centralized training portal that provides knowledge of data processes and can inform and redirect the user to the specific training. A centralized portal may also be provided for data jobs. This presents to the user, in a centralized location, all of the data jobs available. The user can auto-configure, queue, and schedule jobs depending on the test environment.

The centralized portal can also provide a portal for data mining of mainframe data. This presents to a user, searchable mainframe data and can incorporated other databases. The portal eases the need for requiring mainframe skillsets to mine environments.

The platform also enables centralized reporting for quality engineering teams. That is, a central location is provided for usage metrics related to test data, which incorporates internal processes with reporting such as JIRA. The centralized reporting eases the need to require mainframe skillsets to mine environments.

According to one aspect, a system for management mainframe data is provided. The system includes a processor, a communication module coupled to the processor, and a memory coupled to the processor. The memory stores computer executable instructions that when executed by the processor cause the system to provide a data management platform coupled to a mainframe, the mainframe having mainframe data, the data management platform comprising a user interface; provide access, via the data management platform, to a job engine, the job engine configured to execute at least one data job; generate a data model for a plurality of portions of the mainframe, each portion of the mainframe comprising a portion of the mainframe data provided in a corresponding format associated with operations executed by that portion of the plurality of mainframe portions; generate a data model job executable by the job engine, the data model job configured to use the data model to access specific ones of the plurality of mainframe portions based on queries received by the data management platform via the user interface; responsive to receiving a query, the job engine executing the data model job to access mainframe data from at least a plurality of the mainframe portions and process the accessed mainframe data to provide a readable format; and present the processed mainframe data via the user interface.

In certain example embodiments, the query comprises a data mining search for data crossing multiple entities utilizing the mainframe.

In certain example embodiments, wherein the mainframe is utilized in an enterprise system, the multiple entities being units of the enterprise system.

In certain example embodiments, the data model is generated by mapping data access constraints and data formats to specify how to access and pull data from the respective portion of the mainframe.

In certain example embodiments, the system further includes instructions that when executed by the processor cause the system to provide a data mining and reservation module via the user interface; and responsive to executing the query, reserving data in the accessed portions of the mainframe to control data access.

In certain example embodiments, the data access is controlled for analyzing test data generated from mainframe testing.

In certain example embodiments, the test data comprises data generated by processes spanning multiple ones of the plurality of portions of the mainframe.

In certain example embodiments, the system further comprises instructions that when executed by the processor cause the system to provide a front-end asset list module via the user interface; and responsive to an input from the front-end asset list module, use the job engine to execute one or more custom programs to test at least one of: i) a host application in a test region; or ii) an application programming interface (API) in the test region.

In certain example embodiments, the test region comprises at least one application database associated with the host application and/or the API.

In certain example embodiments, the system further includes instructions that when executed by the processor cause the system to: provide a data training module via the user interface; and provide access to at least one of a collaboration software, a training repository, and external resource locators via the data training module.

In another aspect, there is provided a method for managing mainframe data. The method includes providing a data management platform coupled to a mainframe, the mainframe having mainframe data, the data management platform comprising a user interface; providing access, via the data management platform, to a job engine, the job engine configured to execute at least one data job; generating a data model for a plurality of portions of the mainframe, each portion of the mainframe comprising a portion of the mainframe data provided in a corresponding format associated with operations executed by that portion of the plurality of mainframe portions; generating a data model job executable by the job engine, the data model job configured to use the data model to access specific ones of the plurality of mainframe portions based on queries received by the data management platform via the user interface; responsive to receiving a query, the job engine executing the data model job to access mainframe data from at least a plurality of the mainframe portions and process the accessed mainframe data to provide a readable format; and presenting the processed mainframe data via the user interface.

In certain example embodiments, the query comprises a data mining search for data crossing multiple entities utilizing the mainframe.

In certain example embodiments, the mainframe is utilized in an enterprise system, the multiple entities being units of the enterprise system.

In certain example embodiments, the data model is generated by mapping data access constraints and data formats to specify how to access and pull data from the respective portion of the mainframe.

In certain example embodiments, the method further includes providing a data mining and reservation module via the user interface; and responsive to executing the query, reserving data in the accessed portions of the mainframe to control data access.

In certain example embodiments, the data access is controlled for analyzing test data generated from mainframe testing.

In certain example embodiments, the test data comprises data generated by processes spanning multiple ones of the plurality of portions of the mainframe.

In certain example embodiments, the method further includes providing a front-end asset list module via the user interface; and responsive to an input from the front-end asset list module, using the job engine to execute one or more custom programs to test at least one of: i) a host application in a test region; or ii) an application programming interface (API) in the test region.

In certain example embodiments, the method further includes providing a data training module via the user interface; and providing access to at least one of a collaboration software, a training repository, and external resource locators via the data training module.

In another aspect, there is provided a computer readable medium storing computer-executable instructions for managing mainframe data. The computer readable instructions include computer-executable instructions that, when executed by a computing system, cause the system to provide a data management platform coupled to a mainframe, the mainframe having mainframe data, the data management platform comprising a user interface; provide access, via the data management platform, to a job engine, the job engine configured to execute at least one data job; generate a data model for a plurality of portions of the mainframe, each portion of the mainframe comprising a portion of the mainframe data provided in a corresponding format associated with operations executed by that portion of the plurality of mainframe portions; generate a data model job executable by the job engine, the data model job configured to use the data model to access specific ones of the plurality of mainframe portions based on queries received by the data management platform via the user interface; responsive to receiving a query, the job engine executing the data model job to access mainframe data from at least a plurality of the mainframe portions and process the accessed mainframe data to provide a readable format; and present the processed mainframe data via the user interface.

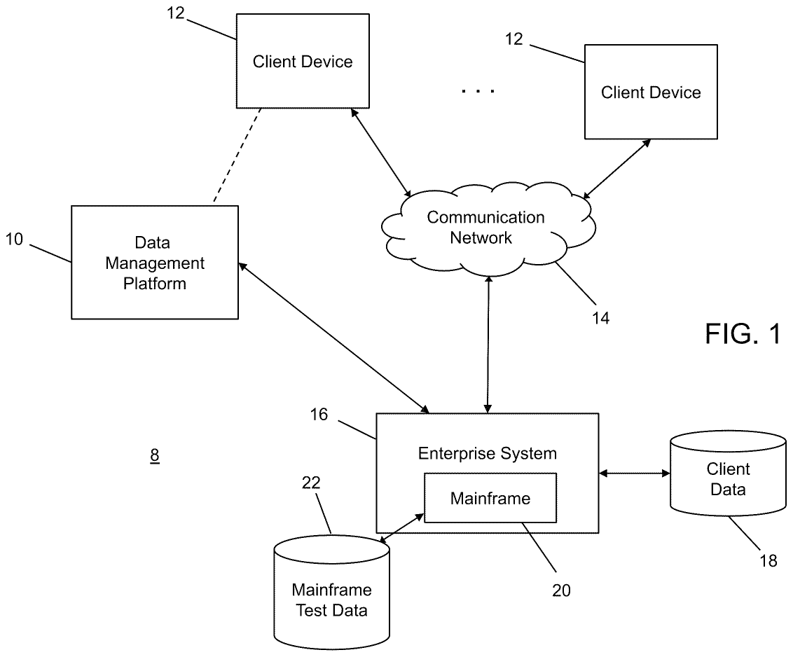

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to a data management platform 10 via the communication network 14 or directly, e.g., when located in a same local environment within the computing environment 8.

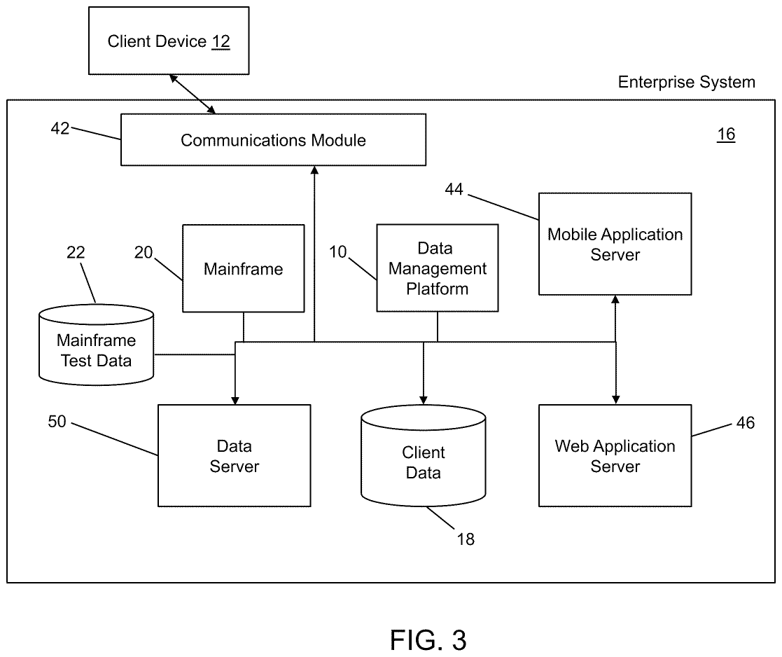

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 3 below for additional details. The enterprise system 16 includes, at least in part, a mainframe 20. The mainframe 20, as known in the art, may be or comprise one or more high-performance computers designed to handle and process vast amounts of data quickly and reliably. These computers are typically used for large-scale transaction processing, critical applications, and bulk data processing tasks.

The enterprise system 16 includes or otherwise has access to a datastore for storing client data 18. The enterprise system 16 may include other datastores not shown in FIG. 1. The data associated with a user can include client profile data that may be mapped to corresponding financial data for that user. It can be appreciated that the financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based financial (banking) application which uses or incorporates subsystems of the enterprise system 16, discussed further below.

The client devices 12 can access information within the data management platform 10 and/or enterprise system 16 or another remote computing environment associated with the enterprise system 16 in a variety of ways. For example, the client device 12 can access the data management platform 10 or enterprise system 16 via a web-based application, or a dedicated application. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices such as point of sale (POS) devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be difficult to migrate into a digital and remote computing environment.

The enterprise system 16 may include both on-premises and remote computing assets provided by a remote computing environment - not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft TM Azure TM data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)^{TM} suite, etc. The computing resources can also include hardware resources, such as access to processing capability of server devices (e.g., cloud computing), and so forth.

The data management platform 10 is shown as a separate entity in FIG. 1 for illustrative purposes and, in other configurations, may be part of or otherwise integrated into/with the enterprise system 16. As shown in FIG. 1, the data management platform 10 may be coupled to or in communication with the mainframe 20, via the enterprise system 16, to permit a user of a client device 12 to execute jobs or tasks related to data management in the mainframe 20 as discussed herein.

Referring back to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

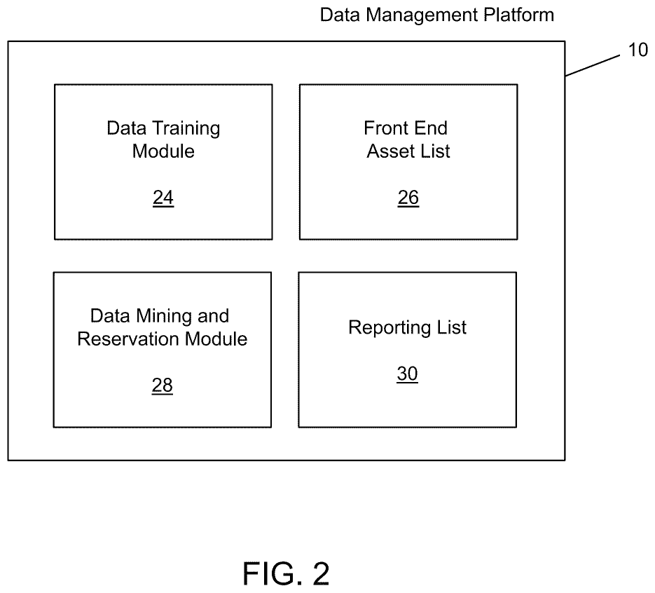

Turning now to FIG. 2, an example configuration of the data management platform 10 is shown. The data management platform 10 may include a data training module 24, a front-end asset list 26, a data mining and reservation module 28, and a reporting list 30. Each of these components 24-30 is described in further detail below.

In FIG. 3, an example configuration of an enterprise system 16 is shown. The enterprise system 16 includes a communications module 42 that enables the enterprise system 16 to communicate with one or more other components of the computing environment 8, such as the data management platform 10 and/or client device(s) 12, via a bus or other communication network, such as the communication network 14. While not delineated in FIG. 3, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 3 illustrates examples of servers and datastores/databases operable within the enterprise system 16. It can be appreciated that any of the components shown in FIG. 3 may also be hosted externally and be available to the enterprise system 16, e.g., via the communications module 42. In the example embodiment shown in FIG. 3, the enterprise system 16 includes one or more servers to provide access to client data 18, e.g., for development or testing purposes. Exemplary servers include a mobile application server 44, a web application server 46 and a data server 50. The enterprise system 16 also includes the mainframe 20 that is subjected to data management as described herein, such as that done via the data management platform 10. Although not shown in FIG. 3, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 44 supports interactions with a mobile application installed on client device (which may be similar or the same as a test device). Mobile application server 44 can access other resources of the enterprise system 16 to carry out requests made by, and to provide content and data to, a mobile application on client device. In certain example embodiments, mobile application server 44 supports a mobile banking application to provide payments from one or more accounts of user, among other things.

Web application server 46 supports interactions using a website accessed by a web browser application running on the client device. It can be appreciated that the mobile application server 44 and the web application server 46 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools and engines are shown in FIGS. 2 and 3 for ease of illustration and various other components would be provided and utilized by the data management platform 10 and enterprise system 16, as is known in the art.

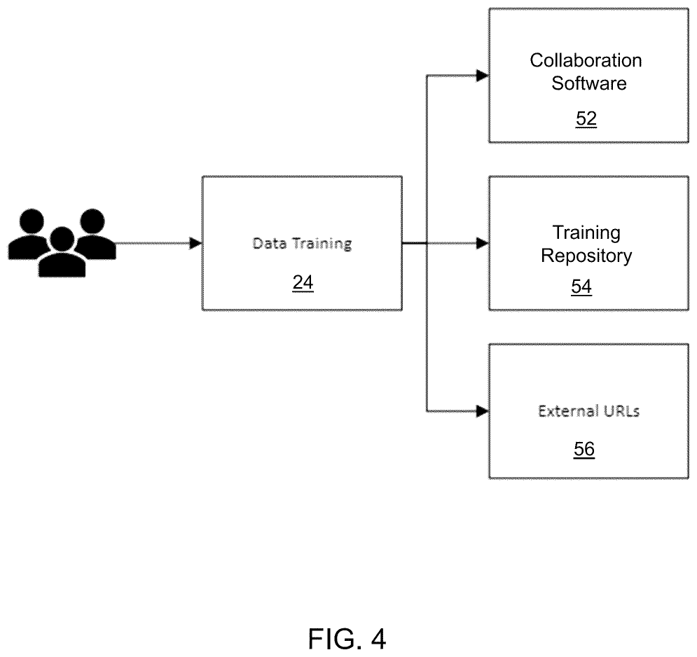

Referring now to FIG. 4 an example of workflow implemented via the data training module 24 is shown. In this example, the data training module 24 may be accessed via the data management platform 10, e.g., via a user interface. The data training module 24 provides access to specific data knowledge by providing a centralized training portal that provides knowledge of data processes and can inform and redirect the user to the specific training. In the process flow shown in FIG. 4, the data training module 24 provides access to collaboration software 52 used by individuals within the enterprise system 16, a training repository 54 for domain-specific knowledge, and external uniform resource locators (URLs) 56, e.g., to provide links to external sources of data. In this way, the data management platform 10 can provide data training resources in the same centralized and self-service tool as other data management tools to permit the user to access these resources when testing, analyzing or mining data in the mainframe 20.

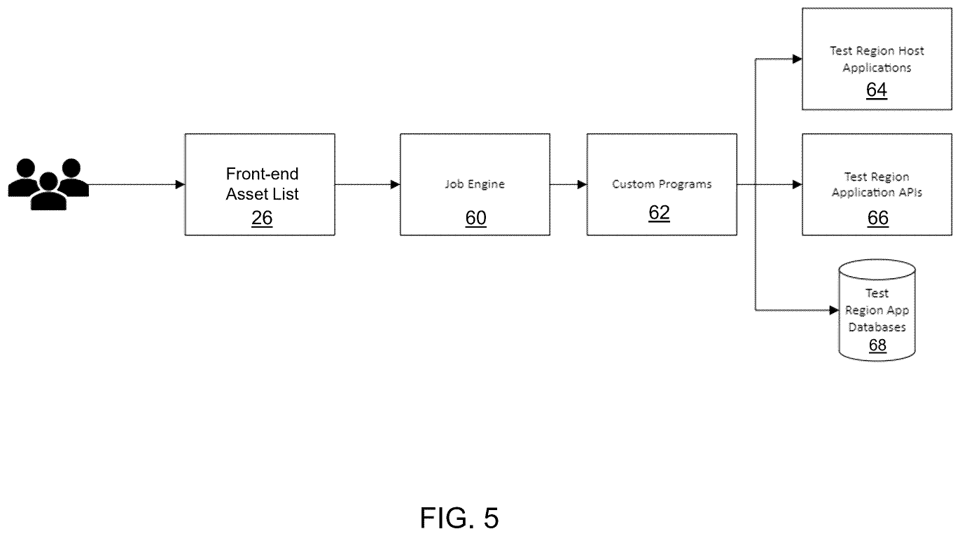

As shown in FIG. 5, the data management platform 10 also provides a centralized portal for data jobs, in this example via the front-end asset list 26. This presents to the user, in a centralized location, all of the data jobs available, by accessing a job engine 60. The user can auto-configure, queue, and schedule jobs depending on the test environment. The job engine 60 may be utilized to access custom programs 62. These custom programs 62 allow the user to configure, queue and schedule the jobs as noted above. For example, the custom programs enable the user to access test region host applications 64 such as applications running on the mainframe 20 for which test data has been generated and is desired for analytics. The custom programs 62 also provide access to test region application APIs 66 such that the user can also configure and control jobs associated with or otherwise utilizing APIs 66. The test region apps may also have a database 68, which the custom programs 62 can access to generate, cache, retrieve, modify and otherwise manage data in the mainframe 20 or other areas of the enterprise system 16.

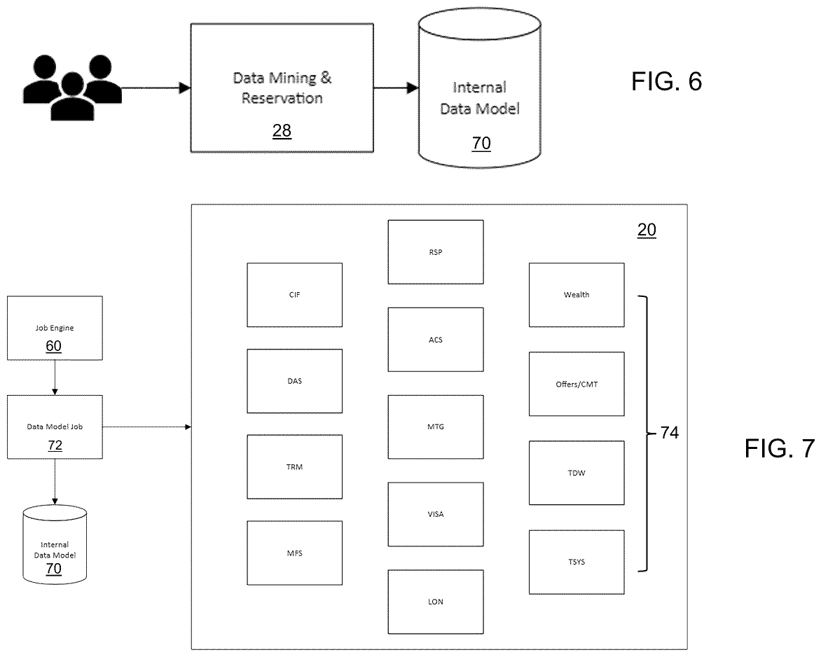

FIGS. 6 and 7 illustrate details of the data mining and reservation module 28 and how the module 28 may be utilized by a user to access searchable mainframe data that can be incorporated with other databases. The portal eases the need for requiring mainframe skillsets to mine environments. As discussed below, the data mining and reservation module 28 can leverage the job engine 60 and an internal data model 70 that maps the mainframe data associated with different areas or portions of the mainframe 20. The internal data model 70 can be generated to provide a layer of abstraction for the different areas 74 of the enterprise system 16 that utilize the mainframe 20 (e.g., as shown in FIG. 7) to avoid the need for the user to have skillsets required to manipulate, format or read different types of datasets.

As shown in FIG. 6, the data mining and reservation module 28 may store or otherwise access the internal data model 70 and may be used to refine, update, edit or configure the data model 70 over time, e.g., to accommodate new areas 74 in the mainframe 20. The data model 70 may provide an abstraction layer or be built using machine learning to enable the module 28 to infer configurations or formats for certain types of mainframe data. The module 28 may access a machine learning module or other artificial intelligence tools (not shown), via the job engine 60, or via other tools or applications available via the client device 10 being used.

The data model job 72, shown in FIG. 7, may be a customized job created to be executed by the job engine 60 to reference the job model 70 to mine, analyze, test other otherwise manage data from the mainframe 20 across different areas 74, such as different business or operational units of the enterprise system 16. The data model 70 allows the data model job 72 to convert, reformat, normalize or otherwise harmonize the data into a readable format for the desired purpose, e.g., to analyze test data that touches multiple areas 74 of the mainframe 20 and enterprise system 16. In this way, there is no need to reprogram or modify the individual areas 74 of the mainframe 20 in order to utilize the associated mainframe data. Moreover, the data model job 72 may be used to reserve data, across multiple areas 74 of the mainframe 20. This allows data to be checked out or frozen to avoid modifications during testing, analyses or other operations being performed by the data model job 72.

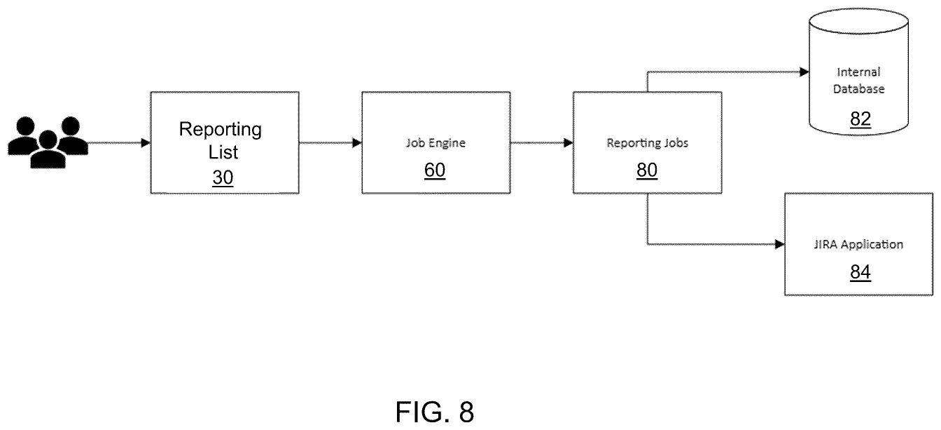

Referring now to FIG. 8, a workflow implemented using the reporting list 30 is shown. In this example, the reporting list 30 may access the job engine 60 to generate or initiate reporting jobs 80. This may utilize data in an internal database 82 and access project management platforms or application such as the JIRA application 84 shown in FIG. 8. The reporting list 30 may therefore provide a single access point for the user to generate reports associated with the mainframe 20 and processes that utilize, test or analyze mainframe data, e.g., by having access to the job engine 60. The reporting jobs 80 may be customizable or predetermined by the system.

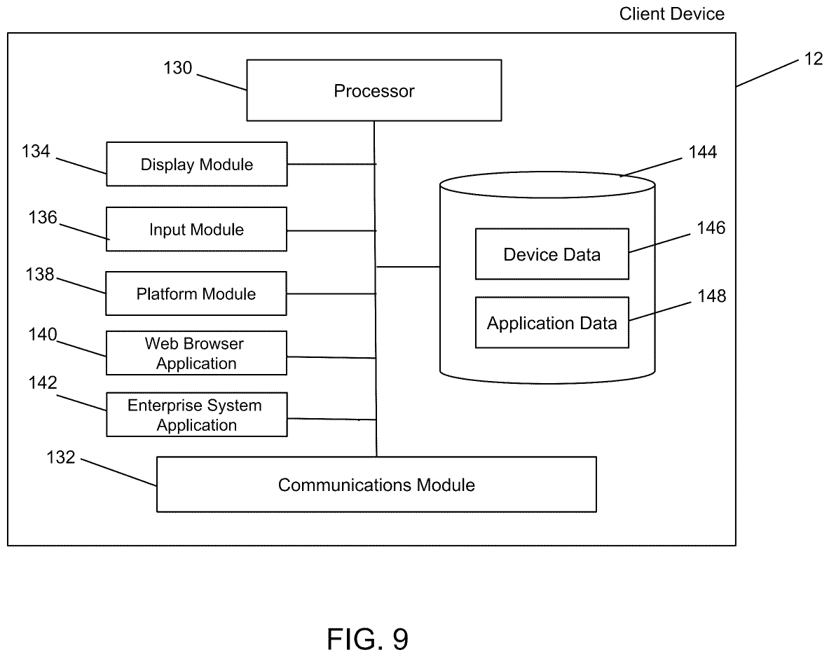

In FIG. 9, an example configuration of a client device 12 is shown. In certain embodiments, the client device 12 may include one or more processors 130, a communications module 132, and a data store 144 storing device data 146 and application data 148. Communications module 132 enables the client device 12 to communicate with one or more other components of the computing environment 8, such as the data management platform 10, via a bus or other communication network, such as the communication network 14. While not delineated in FIG. 9, the client device 12 includes at least one memory or memory device that can include a tangible and non-transitory computer-readable medium having stored therein computer programs, sets of instructions, code, or data to be executed by processor 130. FIG. 9 illustrates examples of modules and applications stored in memory on the client device 12 and operated by the processor 130. It can be appreciated that any of the modules and applications shown in FIG. 9 may also be hosted externally and be available to the client device 12, e.g., via the communications module 132.

In the example embodiment shown in FIG. 9, the client device 12 includes a display module 134 for rendering GUIs and other visual outputs on a display device such as a display screen, and an input module 136 for processing user or other inputs received at the client device 12, e.g., via a touchscreen, input button, transceiver, microphone, keyboard, etc. The client device 12 may also include a platform module 138, which may take the form of a customized app, plug-in, widget, or software component provided by the data management platform 10 for use by the client device 12 to use in mainframe data management operations as described above and further detailed below. Similarly, the client device 12 may include an enterprise system application 142 provided by the enterprise system 16. The client device 12 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 12 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1 to 8 for ease of illustration and various other components would be provided and utilized by the data management platform 10, client device 12, and enterprise system 16 as is known in the art.

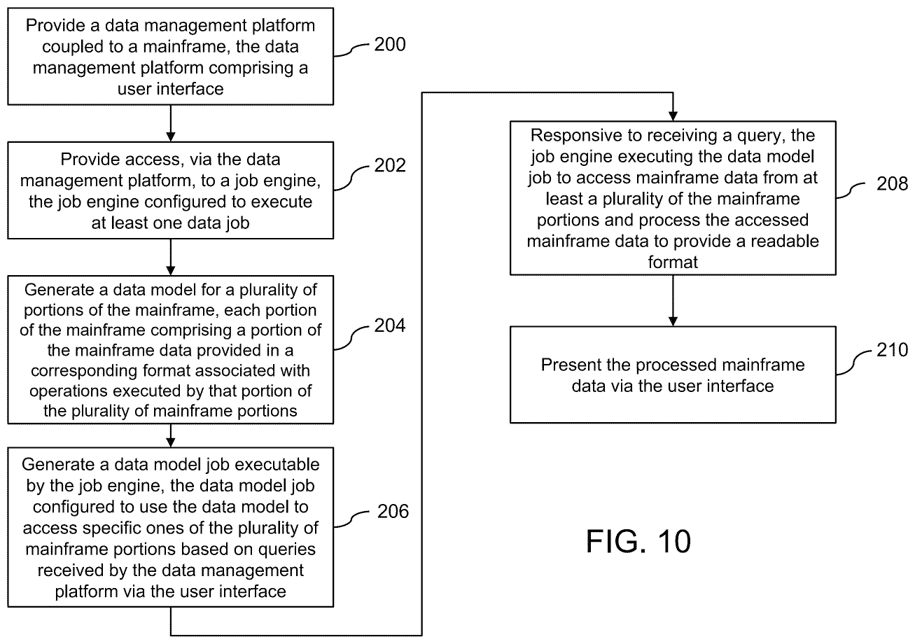

Referring now to FIG. 10, a flow chart illustrates operations that may be performed in managing mainframe data. At block 200, an organization or entity, e.g., associated with the enterprise system 16 provides a data management platform 10. The data management platform 10, as discussed above, is coupled to the mainframe 20, e.g., via the enterprise system 16 or directly. The data management platform 10 may include a user interface to provide access to certain modules as shown in FIG. 2, e.g., using a client device 12.

At block 202, the enterprise system 16 may provide access, via the data management platform 10, to the job engine 60. The job engine 60 is configured to execute one or multiple jobs, e.g., as shown in FIGS. 4-8.

At block 204, a data model 70 is generated for different portions or areas 74 of the mainframe 20, e.g., as shown in FIG. 7. It can be appreciated that blocks 202 and 204 may be performed in a different order than shown in FIG. 10. Each portion or area 74 of the mainframe 20 includes a portion of the mainframe data and the data may be provided in a corresponding format associated with operations that are executed by that portion or area 74 of the mainframe 20. For example, one entity within the enterprise system 16 may use one type of database using one syntax while another entity in the enterprise system 16 may use a different type of database using a different syntax that requires normalization to be used with the other syntax.

At block 206, the data model job 72 is generated (or accessed if already generated) to be executed by the job engine 60. The data model job 72 is configured to use the data model 70 to access specific ones of the portions or areas 74 of the mainframe 20 based on queries received by the data management platform 10. For example, a query related to data mining of test data may use the data model job 72 to reference the data model 70 to determine which data in that area 74 of the mainframe 20 provides the appropriate test data for analysis. The query may be issues automatically or in response to an input via the user interface.

At block 208, responsive to receiving a query, the job engine 60 can execute the data model job 72 to access the mainframe data from multiple ones of the mainframe portions or areas 74 and process the accessed data to provide a readable format, e.g., according to what is requested in the query, the nature of the application, etc.

At block 210, the processed mainframe data is presented in the user interface, e.g., via the data mining and reservation module 28.

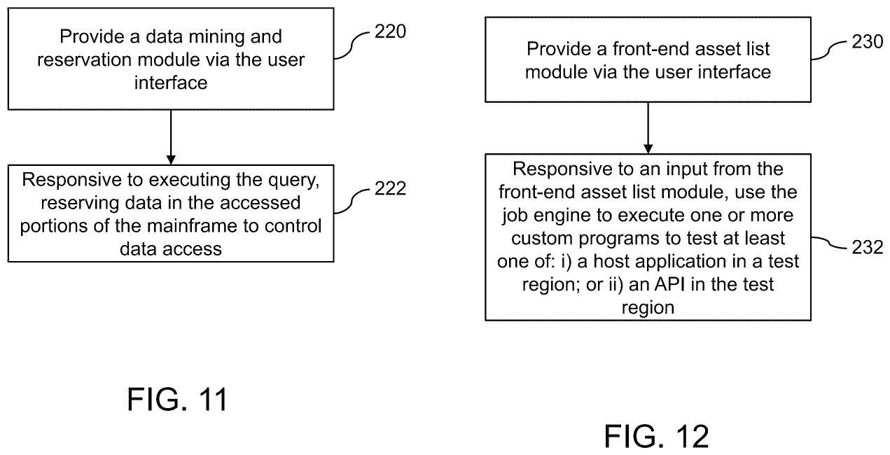

Referring now to FIG. 11, a flow chart is provided illustrating example operations that may be performed in reserving data in accessed portions of a mainframe 20 to control data access. At block 220, the data mining and reservation module 28 is provided via the user interface. At block 222, responsive to executing the query (e.g., from block 208 described above), data may be reserved by the data management platform 10 in the accessed portions of the mainframe 20 to control data access. In this way, test data or operations data used for analytics can be frozen or captured in snapshots without having it modified by other users while accessing and utilizing the data.

FIG. 12 is a flow chart illustrating example operations that may be performed in executing custom programs to test at least a host application in a test region and/or an API in the test region. At block 230, the front-end asset list module 26 may be provided in the user interface. Then, at block 232, responsive to an input from the front-end asset list module 26, the job engine 60 may be used to execute one or more of the custom programs 62, e.g., as shown in FIG. 5. The custom programs 62 may be used to perform various tasks, for example, to test a host application in a test region (e.g., one or more of the areas 74 of the mainframe 20) or an API in the test region. That is, the custom programs 62 can be written to target specific applications or APIs and may be used in connection with, for example, the data mining and reservation module 28 to access and leverage multiple types of data from different areas 74 or regions of the mainframe 20.

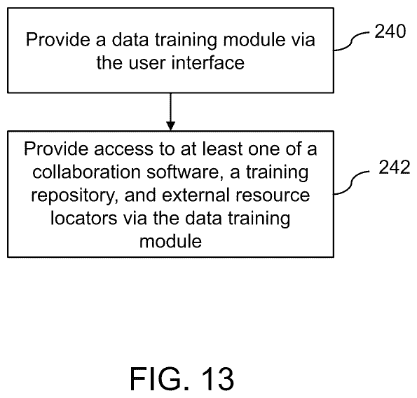

FIG. 13 is a flow chart illustrating example operations that may be performed in providing access to a collaboration software, a training repository, and/or external resource locators via a data training module.

At block 240, the data training module 24 may be provided via the user interface. At block 242, access to various components may be provided, e.g., collaboration software 52, a training repository 54 and external URLs 56. This enables the data management platform 10 to provide a complete view of data associated with the mainframe 20 and portions 74 thereof, including training and domain specific knowledge that can be used in parallel with accessing the mainframe data to reduce the training and expertise required to perform the queries, tasks and processes described herein.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for managing mainframe data, the system comprising:
a processor; and
a memory coupled to the processor, the memory storing computer executable instructions that when executed by the processor cause the system to:
provide a mainframe having mainframe data;
provide a data management platform coupled to the mainframe, the data management platform comprising a user interface;
provide access, via the data management platform, to a job engine, the job engine configured to execute at least one data job;
generate a data model for a plurality of portions of the mainframe, each mainframe portion comprising a portion of the mainframe data provided in a corresponding format associated with operations executed by that mainframe portion;
generate a data model job executable by the job engine, the data model job configured to use the data model to access specific ones of the mainframe portions based on queries received by the data management platform via the user interface;
responsive to receiving a query, the job engine executing the data model job to access mainframe data from the mainframe portions and process the accessed mainframe data to provide a readable format, wherein the job engine executes the data model job using a mapping comprised in the data model, wherein the mapping maps the mainframe portions to respective data access constraints and data formats specifying how to access and pull data from the respective mainframe portions; and
present the processed mainframe data via the user interface.

2. The system of claim 1, wherein the query comprises a data mining search for data crossing multiple entities utilizing the mainframe.

3. The system of claim 2, wherein the mainframe is utilized in an enterprise system, the multiple entities being units of the enterprise system.

4. (canceled)

5. The system of claim 1, further comprising instructions that when executed by the processor cause the system to:
provide a data mining and reservation module via the user interface; and
responsive to executing the query, reserving data in the accessed mainframe portions to control data access.

6. The system of claim 5, wherein the data access is controlled for analyzing test data generated from mainframe testing.

7. The system of claim 6, wherein the test data comprises data generated by processes spanning multiple ones of the mainframe portions.

8. The system of claim 1, further comprising instructions that when executed by the processor cause the system to:
provide a front-end asset list module via the user interface; and
responsive to an input from the front-end asset list module, use the job engine to execute one or more custom programs to test at least one of: i) a host application in a test region; or ii) an application programming interface (API) in the test region.

9. The system of claim 8, wherein the test region comprises at least one application database associated with the host application and/or the API.

10. The system of claim 1, further comprising instructions that when executed by the processor cause the system to:
provide a data training module via the user interface; and
provide access to at least one of a collaboration software, a training repository, and external resource locators via the data training module.

11. A method for managing mainframe data, the method comprising:
providing a mainframe having mainframe data;
providing a data management platform coupled to the mainframe, the data management platform comprising a user interface;
providing access, via the data management platform, to a job engine, the job engine configured to execute at least one data job;
generating a data model for a plurality of portions of the mainframe, each mainframe portion comprising a portion of the mainframe data provided in a corresponding format associated with operations executed by that mainframe portion;
generating a data model job executable by the job engine, the data model job configured to use the data model to access specific ones of the mainframe portions based on queries received by the data management platform via the user interface;
responsive to receiving a query, the job engine executing the data model job to access mainframe data from the mainframe portions and process the accessed mainframe data to provide a readable format, wherein the job engine executes the data model job using a mapping comprised in the data model, wherein the mapping maps the mainframe portions to respective data access constraints and data formats specifying how to access and pull data from the respective mainframe portions; and
presenting the processed mainframe data via the user interface.

12. The method of claim 11, wherein the query comprises a data mining search for data crossing multiple entities utilizing the mainframe.

13. The method of claim 12, wherein the mainframe is utilized in an enterprise system, the multiple entities being units of the enterprise system.

14. (canceled)

15. The method of claim 11, further comprising:
providing a data mining and reservation module via the user interface; and
responsive to executing the query, reserving data in the accessed mainframe portions to control data access.

16. The method of claim 15, wherein the data access is controlled for analyzing test data generated from mainframe testing.

17. The method of claim 16, wherein the test data comprises data generated by processes spanning multiple ones of the mainframe portions.

18. The method of claim 11, further comprising:
providing a front-end asset list module via the user interface; and
responsive to an input from the front-end asset list module, using the job engine to execute one or more custom programs to test at least one of: i) a host application in a test region; or ii) an application programming interface (API) in the test region.

19. The method of claim 11, further comprising:
providing a data training module via the user interface; and
providing access to at least one of a collaboration software, a training repository, and external resource locators via the data training module.

20. A non-transitory computer readable medium storing computer-executable instructions for managing mainframe data, comprising computer-executable instructions that, when executed by a computing system, cause the system to:
provide a mainframe having mainframe data;
provide a data management platform coupled to the mainframe, the data management platform comprising a user interface;
provide access, via the data management platform, to a job engine, the job engine configured to execute at least one data job;
generate a data model for a plurality of portions of the mainframe, each mainframe portion comprising a portion of the mainframe data provided in a corresponding format associated with operations executed by that mainframe portion;
generate a data model job executable by the job engine, the data model job configured to use the data model to access specific ones of the mainframe portions based on queries received by the data management platform via the user interface;
responsive to receiving a query, the job engine executing the data model job to access mainframe data from the mainframe portions and process the accessed mainframe data to provide a readable format, wherein the job engine executes the data model job using a mapping comprised in the data model, wherein the mapping maps the mainframe portions to respective data access constraints and data formats specifying how to access and pull data from the respective mainframe portions; and
present the processed mainframe data via the user interface.

21. The system of claim 1, wherein the data model is generated using machine learning.

22. The method of claim 11, wherein the data model is generated using machine learning.
